(19) United States
(12) Patent Application Publication
(10) Pub. No.: US 2003/0004049 A1
(43) Pub. Date: Jan. 2, 2003

(54) Glass fibers with improved durability via low MgO and Al2O3

(76) Inventors: Stephanie M. Mattson, Newark, OH (US); Charles F. Rapp, Newark, OH (US)

Correspondence Address: PATENT ADMINISTRATOR, OWENS CORNING SCIENCE & TECHNOLOGY, 2790 COLUMBUS ROAD, BLDG 54-1, GRANVILLE, OH, 43023, US

(21) Appl. No.: 09/809,955

(22) Filed: Jul. 16, 2001

Related U.S. Application Data
(63) Continuation of application No. PCT/US99/19383, filed on Aug. 24, 1999.

(30) Foreign Application Priority Data
Sep. 18, 1999 (US) 60100998

(51) Int. Cl. C03C 13/00; C03C 3/091; C03C 3/087

(52) U.S. Cl. 501/35; 501/66; 501/70

(57) ABSTRACT

The glass compositions of the present invention contain a limited amount of Al₂O₃ and MgO resulting in a glass fiber having an acceptable chemical durability for product performance while providing a relatively high biosolubility. The composition includes an amount of BaO which improves fiber durability while controlling viscosity and other processing parameters. The compositions further include amounts of Na₂O, K₂O, and CaO, which have the effect of increasing fiber biosolubility and allows for the use of reduced amounts of Al₂O₃ and MgO in the composition. The glass compositions of the present invention have KI values that generally equal or exceed a KI value of 40 and are suitable for rotary processing. The compositions have liquidus temperatures below about 1600° F., and have a ΔT (T at 1000 Poise−liquidus T) of at least 130° F.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

The present invention is directed generally to glass compositions, and more particularly to glass fiber compositions having high KI values and durability.

Glass fiber, or fiberglass, insulation is well known and has been a commercial product for many years. Glass fiber insulation is widely used both residentially and commercially.

Generally, the insulation is made from intertwined soda lime alumina borosilicate glass fibers which are held together with a binder. The glass fibers are generally produced using SiO₂with a number of additives, such as Na₂O, K₂O, CaO, MgO, BaO, B₂O₃, and Al₂O₃, that enhance various properties of fibers. The binder may be any suitable material, but quite commonly is a phenol-formaldehyde resin or a urea formaldehyde resin.

A rotary process is often used to form the glass fibers. The rotary process typically involves the introduction of molten glass into a rotating device, called a spinner, which contains a plurality of holes circumferentially distributed around the spinner. The spinner is rotated about an axis to produce a centrifugal force on the molten glass. The rotation of the spinner forces the molten glass through the plurality of holes.

An annular stream of hot gases is passed around the spinner to contact and attenuate the fibers passing through the holes. A spray nozzle is positioned to coat the attenuated fibers with the binder.

A conveyer collects the binder-coated fibers in the form of a blanket, or batt, and the blanket is heat cured to produce the final insulation. The rotary process can be used to produce insulation having different densities by varying the conveyer speed and the thickness of the cured insulation.

Glass fiber insulation has been used to replace, or in lieu of, asbestos fiber insulation in many applications. It is generally believed that asbestos fibers, when inhaled, can result in significant disease in man. Though the exact mechanism responsible for the biological activity of asbestos fibers is unknown, it is widely believed that an important factor in the mechanism is the residence time of the fibers in the lungs.

Unlike asbestos fibers, glass fibers have not been linked to disease in man. Glass fiber also appears to have a much shorter residence time in the lungs than asbestos fibers.

The residence time of glass fibers in the lungs will depend, at least in part, upon chemical dissolution of the fiber. The rate of chemical dissolution of a material in biological fluid is generally referred to as the biosolubility or biological degradability of the material.

Despite the lack of a link between glass fibers and human disease, some countries, for example Germany, have proposed regulations for the use of glass fibers in insulation products. Glass fiber compositions that meet the standard in the proposed regulations are considered to be free of suspicion as a disease causing agent and can be used for both commercial and residential installations.

The regulations are based on a desire to minimize the residence time of the glass fiber in the lungs. It is a hope that minimizing the residence time of the glass fiber will decrease the possibility, if any, of subsequent disease.

The proposed German regulations for biosolubility require that glass fibers have a numerical index (KI) greater than or equal to 40 to be considered to be free of suspicion. The KI index, which is sometimes referred to as the Wardenbach Index, is described by the equation:

KI=Σ(Na₂O, K₂O, CaO, MgO, BaO, B₂O₃)−2(Al₂O₃)

where the values for each oxide correspond to the weight percentage of that oxide in the glass composition.

The index used in the regulation places severe constraints on the compositions of the glass, expressly on the levels of alumina (Al₂O₃) and implicitly on the level of silica (SiO₂) in the glass composition. Manufacturers must now produce glass fibers which meet the proposed regulations, while maintaining standard performance criteria for the products. The criteria include that the glass fiber must be producible using standard wool processes, have sufficient durability in use, and acceptable insulating properties.

Silica is the primary component in glass fiber and provides most of the structural and physical properties of the fiber. Alumina is primarily used in the fiber to provide additional durability to the fiber.

Initial attempts to produce glass fiber that complies with the regulations involved using reduced levels of alumina in the glass composition to increase the KI index. However, low alumina glass fibers tend to have poor durability.

A number of glass composition have been reported as having improved biosolubility or biodegradability. For example, Potter, U.S. Pat. No. 5,055,428, Cohen et al., U.S. Pat. No. 5,108,957, Nyssen, U.S. Pat. No. 5,332,698, Bauer et al., U.S. Pat. No. 5,401,693, and Mattson et al., U.S. Pat. Nos. 5,523,264 and 5,523,265 (which are each incorporated herein by express reference) all describe glass fibers having improved biosolubility. Also, published PCT applications WO 97/49643, WO 95/31411, WO 95/32925, WO 95/32926, WO 95/32927, and WO 95/35265 and numerous published German applications such as DE 19631782A1 have reported glass compositions having increased biodegradability.

Glass compositions conforming to the KI index regulations generally provide for increased levels of B₂O₃to compensate in part for the increased levels of alumina. However, a disadvantage of including increased levels of B₂O₃ are higher costs associated with B₂O₃. Another disadvantage is that B₂O₃ is volatile and higher concentrations produce higher emissions that must be controlled, which can further lead to increased costs. For these reasons, it is preferred to limit the B₂O₃ content to less than 15%.

The use of high levels of MgO in glass compositions conforming to the KI index regulations decreases the Al₂O₃ content but with a resulting decrease in the durability of the fibers.

Despite the improvements presented in the aforementioned patents and applications, the glasses failed to meet the KI≧40 standard or significant processing and performance problems remain. The decreased performances and increased processing costs for glass compositions designed to meet the new biological standards is a clear shortcoming in the industry. In addition, higher alumina compositions of the prior art provide performance versatility, yet are either not acceptable in the emerging regulated marketplace or suffer from increased processing costs. The use of MgO in place of Al₂O₃ increases the KI index of the fiber composition but with a decrease in fiber durability. Accordingly, there is still a need for a glass composition which has increased biosolubilities (KI value≧40), while possessing acceptable processing properties, such as viscosity and liquidus temperatures, as well as acceptable performance and durability in use.

### BRIEF SUMMARY OF THE INVENTION

The above objectives and others are accomplished by glass fibers having compositions in accordance with the present invention. The glass fibers contain a limited amount of Al₂O₃ and MgO resulting in fibers having an acceptable chemical durability for product performance while providing a relatively high biosolubility. The composition includes an amount of BaO which improves fiber durability while controlling viscosity and other processing parameters. The compositions further include amounts of Na₂O, K₂O, and CaO, which have the effect of increasing fiber biosolubility and allows for the use of reduced amounts of Al₂O₃ and MgO in the composition.

The glass compositions have KI values that generally equal or exceed a KI value of 40 and are suitable for rotary processing. The compositions have liquidus temperatures below about 1600° F., and have a ΔT (T at 1000 Poise−liquidus T) of at least 130° F.

In one aspect of the invention, BaO is substituted for B₂O₃ to improve durability at alumina levels approaching 1% In one aspect of the invention, the total amounts of Fe₂O₃, TiO₂ and ZrO₂ are limited. Preferably the total amounts of iron, titanium and zirconium oxides are limited to less than 1% (for clarity all percentages are percent by weight unless otherwise noted).

A glass fiber compositions having 49-59 percent by weight SiO₂; 0.9-2 percent by weight Al₂O₃; 0-3 percent by weight MgO; 2-13 percent by weight BaO; 5-12 percent by weight CaO; 0-22 percent by weight K₂O and Na₂O; 0-22 percent by weight B₂O₃ as well as small amounts of other oxides provide a durable, biosoluble fiber which satisfies the equation:

(BaO+B₂O₃+Na₂O+K₂O+MgO+CaO)−2*Al₂O₃≧40.

The compositions of the present invention provides glass compositions that meet proposed biosolubility standards, while maintaining acceptable performance and durability as glass fiber insulation. Accordingly, the present invention overcomes the aforementioned difficulties of the prior art in meeting both public health standards and commercial requirements. These advantages and others will become apparent from the following detailed description of the invention.

### DETAILED DESCRIPTION OF THE INVENTION

The present invention will be described generally with reference to present preferred embodiments of the invention only for the purpose of providing examples of the invention and not for purposes of limiting the same.

The applicants have found that acceptable glass processing and fiber biosolubility and durability can be maintained in glass fiber by providing compositions including alumina in a range of 0.9-2%, magnesia in the range of 0-3%, B₂O₃ in the range of 2-13%, and increased levels of alkali and alkaline earth oxides over the prior art. Compositions of the present invention provide a balance between increased durability and biosolubility to address the shortcomings of the prior art.

The SiO₂ content in compositions of the present invention ranges from 50-57%.

The Al₂O₃ content in the composition should be less than approximately 2% to provide sufficient performance durability without substantial deterioration of the biosolubility of the fibers. It is preferable that the alumina content of the composition ranges from 0.9-2% to control the biosolubility.

To achieve the desired KI values it is desirable to reduce the amount of alumina which allows for an increase in the amount of silica as well as a reduction in the amount of modifiers such as BaO, CaO, Na₂O, B₂O₃ and K₂O necessary.

Decreased levels of alumina decreases the durability of the fibers, however it has been discovered that reducing the levels of MgO with the decreased levels of alumnia increases the durability of the fiber. Specifically, of the modifiers, CaO substantially increases the durability of glass fibers. However, increased CaO levels increases the liquidus temperature as well as decreases the viscosity of the glass which results in difficulty forming the fibers during spinning. Increased amounts of MgO improve the KI index, however increased MgO levels reduce the durability of the resulting fibers.

Na₂O is included in an amount ranging from approximately 12-20% depending on the desired properties. Na₂O will generally provide for lower viscosities and better melting characteristics for the glass.

K₂O is typically an impurity which is included in the alumina. The K₂O is typically less than approximately 2% depending upon the amount and purity of the alumina included in the composition. K₂O at low levels tends to enhance the characteristics associated with Na₂O.

MgO is included in the composition ranges from 0-3% to provide for somewhat lower liquidus temperatures and viscosities at a lower cost. Preferably the MgO levels are in the range of 0-2%. When MgO is included in quantities less than approximately 3%, the resulting glass fibers have improved durability with respect to water.

CaO is included in the composition in quantities ranging from 5-12%. The CaO provides for a lower viscosity and improved durability.

BaO is included in an amount of 2%-13%. BaO is added to compensate for the lowered amount of MgO. The use of BaO provides for increased durability over fibers including higher amounts of MgO, without the decreased viscosity caused by the inclusion of CaO. The use of BaO has been found to increase durability and control processing parameters such as viscosity while maintaining the desired KI index.

B₂O₃ is included in the composition in quantities ranging from 0-22%. The B₂O₃ primarily serves to significantly lower the liquidus temperature and the viscosity of the composition.

In view of the disadvantages associated with the various constituents included in glass compositions, the present invention attempts to balance the composition while decreasing the amount of Al₂O₃ and MgO to provide for more versatile and better performing glass while maintaining a suitable biosolubility.

The following examples are provided to demonstrate the present invention and not to limit the same.

### EXAMPLES

A number of compositions were prepared by methods known in the art to provide examples of compositions of the present invention. For each sample, the liquidus temperature of the composition was determined. Also, the temperature at which the viscosity of the glass is approximately 1000 poise (Tlog3 viscosity) was determined. The ΔT, the difference between the Tlog3 viscosity and the liquidus temperature, is labeled as “visc-liqu.”

In addition, durability testing was performed by preparing 10 μm diameter continuous fibers from each composition. A 1 g sample of the fiber was placed in 100 ml of water and maintained at a temperature of 205° F. for 24 hours. Following the water exposure, the sample was removed from the water, dried and weighed. The post-test weight of the sample was compared to the pretest weight to calculate the % weight loss during testing.

As can be seen from the examples in the attached table, compositions of the present invention provide for decreased levels of alumina and magnesia, while remaining within the proposed KI index requirements and maintaining suitable durability and AT. Theoretically acceptable compositions for rotary process glass fiber production appear to be possible with less than 2% Al₂O₃ and less than about 3% MgO.

In addition, the present invention provides for decreasing the amount of Al₂O₃ and MgO used in glass compositions. The durable fibers of these compositions meet both the KI index regulations and can be processed by standard rotary methods.

The examples demonstrate that compositions within the present invention can be employed in various quantities to tailor specific properties of the compositions. Example 7 shows the effect of MgO may be overwhelmed by high concentrations of B₂O₃. Example 10 shows the deleterious effect of including greater than 3% MgO. Examples 24-27 show the deleterious effects of high iron, titanium and zirconium oxides as compared to Example 23 which is the base case.

Those of ordinary skill in the art will appreciate that a number of modifications and variations that can be made to specific compositions of the present invention without departing from the scope of the present invention. Such modifications and variations are intended to be covered by the foregoing specification and the following claims.

What is claimed is:

1. A glass fiber formed of a composition comprising:
49-59 percent by weight SiO₂;
0.9-2 percent by weight Al₂O₃;
0-3 percent by weight MgO; 1-13 percent by weight BaO;
5-12 percent by weight CaO;
0-22 percent by weight K₂O and Na₂O;
0-22 percent by weight B₂O₃,
wherein said glass fiber has a fiber weight loss of less than 4% after exposure to water at 205 F for 24 hours and a ΔT of at least 130 F.

2. The glass fiber of claim 1, wherein said composition satisfies the equation:
(BaO+B₂O₃+Na₂O+K₂O+MgO+CaO)−2(Al₂O₃)≧40.

3. The glass fiber of claim 1, wherein the B₂O₃ content ranges from 0-15 percent by weight.

4. The glass fiber of claim 1, wherein said ingredients include, in weight percent:

| | |
|---|---|
| SiO₂ | 50-57; |
| Al₂O₃ | 0.9-2; |
| BaO | 2-12 |
| B₂O₃ | 6-15; |
| Na₂O | 13-20; |
| K₂0 | 0-2; |
| MgO | 0-2; and, |
| CaO | 5-12. |

5. The composition of claim 1 wherein said composition has a liquidus temperature <1600° F.

6. The glass fiber of claim 1, wherein said ingredients include approximately, in weight percent:

| | |
|---|---|
| SiO₂ | 54; |
| Al₂O₃ | 1.9; |
| BaO | 2.1; |
| B₂O₃ | 11; |
| Na₂O | 19; |
| K₂O | .45; |
| MgO | 1.8; and, |
| CaO | 8.2. |

with the balance being oxides of iron, zirconium, titanium and sulfur as well as unavoidable impurities.

7. A glass fiber insulation product containing glass fibers comprising:
49-59 percent by weight SiO₂;
0.9-2 percent by weight Al₂O₃;
0-3 percent by weight MgO;
2-13 percent by weight BaO;
5-12 percent by weight CaO;
0-22 percent by weight K₂O and Na₂O;
0-22 percent by weight B₂O₃,
wherein said glass fiber has a fiber weight loss of less than 4% after exposure to water at 205 F for 24 hours and a ΔT of at least 130 F.

8. The glass fiber insulation product of claim 7, wherein said composition satisfies the equation:
(BaO+B₂O₃+Na₂O+K₂O+MgO+CaO)−2(Al₂O₃)≧40.

9. The glass fiber insulation product of claim 7, wherein the B₂O₃ content ranges from 0-15 percent by weight.

10. The glass fiber insulation product of claim 7, wherein said ingredients include, in weight percent:

| | |
|---|---|
| SiO₂ | 50-57; |
| Al₂O₃ | 0.9-2; |
| BaO | 1-12 |
| B₂O₃ | 6-15; |
| Na₂O | 13-20; |
| K₂O | 0-2; |
| MgO | 0-2; and, |
| CaO | 5-12. |

11. The glass fiber insulation product of claim 7 wherein said composition has a liquidus temperature <1600° F.

12. The glass fiber insulation product of claim 7, wherein said ingredients include approximately, in weight percent:

| | |
|---|---|
| SiO₂ | 54; |
| Al₂O₃ | 1.9; |
| BaO | 2.1; |
| B₂O₃ | 11; |
| Na₂O | 19; |
| K₂O | .45; |
| MgO | 1.8; and, |
| CaO | 8.2. |

with the balance being oxides of iron, zirconium, titanium and sulfur as well as unavoidable impurities.

13. The glass fiber insulation product of claim 7, further comprising:
a binder for retaining the fibers in a predetermined shape.

14. A method of preparing glass fiber comprising the steps of:
providing a glass melt having a composition comprising, in weight percent:
49-59 percent by weight SiO₂;
0.9-2 percent by weight Al₂O₃;
0-3 percent by weight MgO;
1-13 percent by weight BaO;
5-12 percent by weight CaO;
0-22 percent by weight K₂O and Na₂O;
0-22 percent by weight B₂O₃,
wherein said glass fiber has a fiber weight loss of less than 4% after exposure to water at 205 F for 24 hours and a ΔT of at least 130 F; and
spinning the glass melt to form a plurality of fibers.

15. The method of claim 14, wherein said composition satisfies the equation:
(BaO+B₂O₃+Na₂O+K₂O+MgO+CaO)−2(Al₂O₃)≧40.

16. The method of claim 14, wherein the B₂O₃ content ranges from 0-15 percent by weight.

17. The method of claim 14, wherein said ingredients include, in weight percent:

| | |
|---|---|
| SiO₂ | 50-57; |
| Al₂O₃ | 0.9-2; |
| BaO | 2-12 |
| B₂O₃ | 6-15; |
| Na₂O | 13-20; |
| K₂O | 0-2; |
| MgO | 0-2; and, |
| CaO | 5-12. |

19. The method of claim 14 wherein said composition has a liquidus temperature <1600° F.

20. The method of claim 14, wherein said ingredients include approximately, in weight percent:

| | |
|---|---|
| SiO₂ | 54; |
| Al₂O₃ | 1.9; |
| BaO | 2.1; |
| B₂O₃ | 11; |
| Na₂O | 19; |
| K₂O | .45; |
| MgO | 1.8; and, |
| CaO | 8.2. |

with the balance being oxides of iron, zirconium, titanium and sulfur as well as unavoidable impurities.
